(19) United States
(12) Patent Application Publication
(10) Pub. No.: US 2005/0141084 A1
(43) Pub. Date: Jun. 30, 2005

(54) High-contrast front projector and screen

(76) Inventor: Richard C. Waters, Concord, MA (US)

Correspondence Address: Patent Department;Mitsubishi Electric Research Laboratories, Inc., 201 Broadway, Cambridge, MA, 02139, US

(21) Appl. No.: 10/747,383

(22) Filed: Dec. 29, 2003

(51) Int. Cl. G03B 21/56

(52) U.S. Cl. 359/443

(57) ABSTRACT

A high contrast front projection system includes a reflective screen configured to reflect light in a plurality of narrow-band frequencies, and a projector configured to emit light substantially in the narrow-band frequencies. The narrow-band frequencies are centered on red, green, and blue colors such that the reflective screen reflects about 90% of light at the plurality of narrow-band frequencies, and less than 10% of light at other frequencies.

### FIELD OF THE INVENTION

This invention relates generally to projectors, and more particularly to high-contrast front projectors and screens.

### BACKGROUND OF THE INVENTION

Various projectors, such as LCD-based, DLP-based, and film projectors, use a front projection screen to display images. With a front projector, the viewer is on the same side of the projection screen as the projector.

To project images, the projector renders light of appropriate colors and intensities. To render the color ‘black’, the projector projects no light. As a result, black on the screen is actually whatever color is produced by any ambient light reflecting on the screen. Other colors are produced by the sum of the ambient light and the projected colors.

In order to show colors clearly and brightly, projection screens are typically white, or nearly white. Thus, all colors appear clear and bright. However, if the ambient light intensity is high, then the color black projected on the screen appears white because this is the color of the screen itself in a brightly lit room. Therefore, an image that is projected in black and white is actually seen not in black and white, but rather in dim white and bright white. Because the human eye adjusts to the brightest white in view, the image appears more-or-less as black and white, but the contrast is lower than it would be if the image were really true black and white.

A common way to deal with this problem is to turn off the lights in the viewing room. For instance, movie theaters are typically very dark inside when the movie is being shown. In that case, the ‘black’ on the screen really is black, and the ‘white’ is white and the contrast between the two color extremes is high.

However, there are numerous situations where it is inconvenient to make the room dark. For example, during a meeting, the room typically needs to be light enough for the audience to see each other and to take notes. This means that the black in the image will only be dim white, instead of black.

Similarly, in the home, it is often inconvenient to make a room completely dark. This is particularly true during the daytime, when special shades or a windowless room are needed to achieve a significant level of darkness.

One way to increase the apparent contrast is to change the color of the projection screen, for example, to a neutral light gray in color instead of white. The effect of this is to make all colors slightly darker than the colors would be on a white screen. Although a gray screen makes white less white, which is a disadvantage, at the same time, black appears darker, which is an advantage.

For a screen that is slightly gray, the advantage gained by blacker blacks is greater than the disadvantage of grayer whites, and the contrast appears improved compared to a white screen. If the gray becomes too dark however, then the disadvantage of grayer whites is greater than the advantage of blacker blacks and the image quality is reduced in comparison to a white screen.

FIG. 1 shows the color response for a conventional ‘wide-band’ projection screen. As shown in FIG. 1, ‘white’ light is composed of a full range of visible light frequencies with approximately equal intensity at each frequency. The perceived brightness to the human eye of the light is related to the area under the curve. That is to say, the brightness is related to the sum of the amount of reflected light at each frequency.

In FIG. 1, the percentage of reflected light is shown on the vertical axis, and the frequency on the horizontal axis. The line 101 is the reflectance for a white screen, while the line 102 is for the reflectance for a gray screen. As shown in FIG. 1, a conventional screen reflects all frequencies of visible light more or less equally. A neutral gray screen reflects light less well at each frequency.

Because using approaches like a slightly gray screen are only partly effective, there remains a need to provide enhanced image contrast when using a front projector in a lighted room.

### SUMMARY OF THE INVENTION

A high contrast front projection system includes a reflective screen configured to reflect light in a plurality of narrow-band frequencies, and a projector configured to emit light substantially in the narrow-band frequencies.

The narrow-band frequencies are centered on red, green, and blue colors such that the reflective screen reflects about 90% of light at the narrow-band frequencies, and less than 10% of light at other frequencies.

### BRIEF DESCRIPTION OF THE DRAWINGS

FIG. 1 is a graph of reflectance for prior art projector screens;

FIG. 2 is a graph of reflectance for a projector screen according to the invention;

FIG. 3 is a narrow-band projector screen according to the invention;

FIG. 4 is an alternative embodiment of a narrow-band projector screen according to the invention;

FIG. 5 is a graph of light produced by a prior art projector; and

FIG. 6 is a graph of light produced by a narrow-band projector according to the invention.

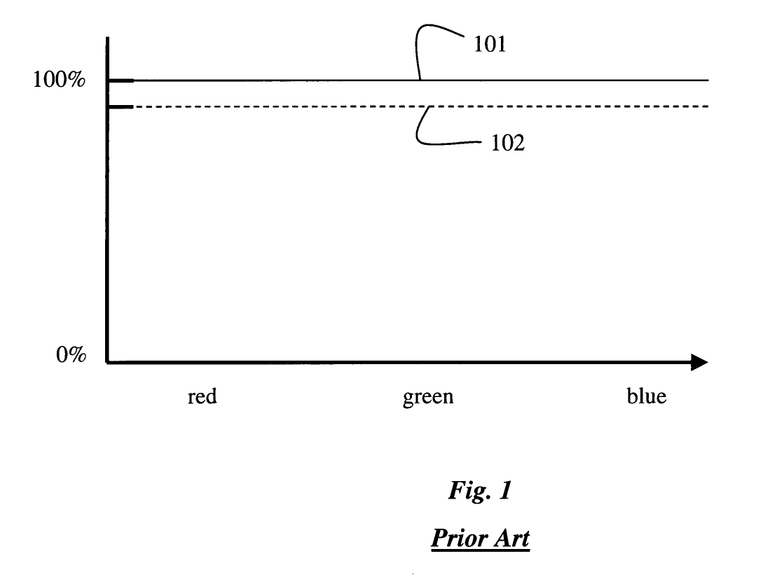

### DETAILED DESCRIPTION OF THE PREFERRED EMBODIMENT

The invention utilizes a ‘narrow-band’ projection screen, and corresponding ‘narrow-band’ projector to achieve high contrast when images are projected onto the screen in a lighted room. The effect of this combination makes projected ‘black’ colors to appear much blacker in a lighted room, while white colors remain white.

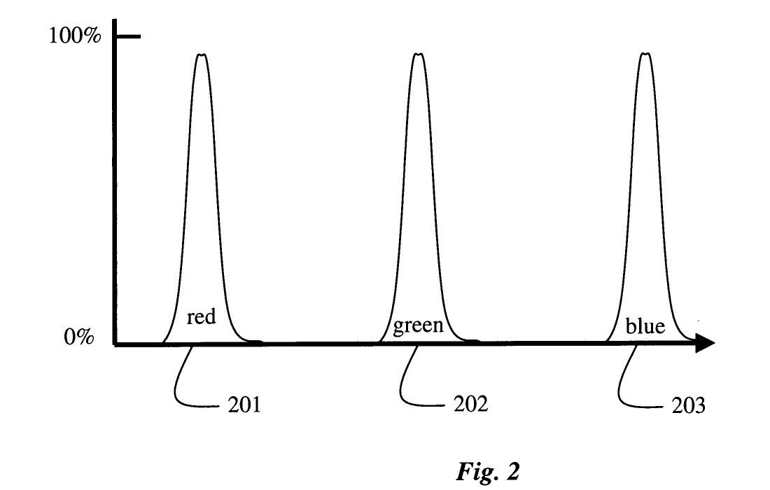

FIG. 2 shows the reflective properties of a narrow-band projection screen according to the invention. Instead of reflecting light equally at all visible frequencies as in the prior art, the narrow-band screen reflects visible light at three very small frequency bands, centered on red 201, green 202, and blue 203 colors. Light at other frequencies is reflected poorly, or not at all. For example, the screen reflects 90% of the light in these three frequency bands, but less than 10% of the light at other frequencies.

Conventional white screens are typically made by combining many tiny reflectors, e.g., grains of quartz, which reflect all frequencies equally well.

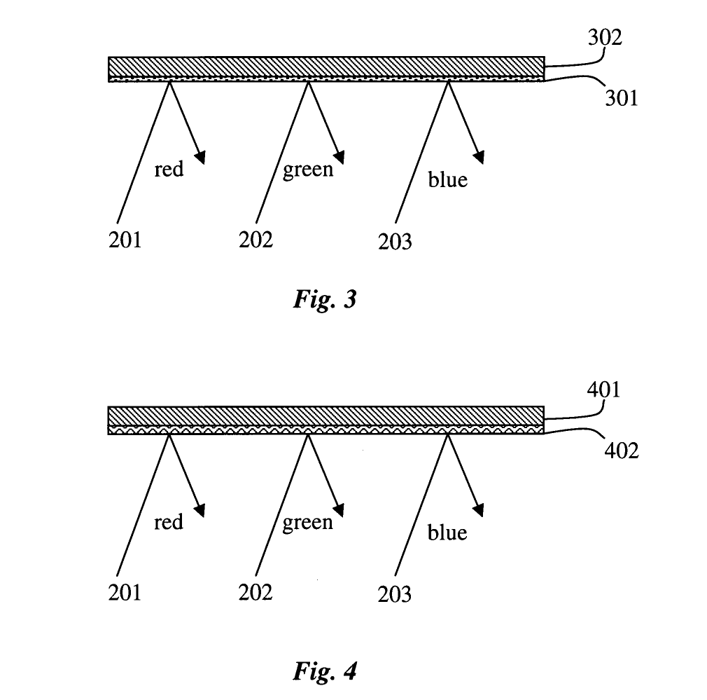

In contrast, as shown in FIG. 3, reflectors 301 used with a narrow-band 302 screen according to the invention reflect only light at the selected narrow-band frequencies.

Alternatively, as shown in FIG. 4, a screen 401 is covered by a color filter 402 that absorbs all frequencies except for the narrow band frequencies 201-203.

Narrow band reflectors 301 and filters 402 can be constructed in a number of ways. One way is to use interference filters. These can be designed to reflect or transmit only in very narrow frequency ranges. Another approach is to use holography. For instance, a narrow band reflector 301 can be created by making a reflectance color hologram of a white background illuminated solely by the desired narrow bands of light.

Typically, color image projectors operate by projecting a combination of red light, green light, and blue light (RGB). Because color perception in the human eye is based on only three different kinds of receptors, it is possible to mimic a wide range of natural colors by varying the ratio of the intensity of just three different colors in the projector. This is the basic principle for color photos, color printing, color TV and many other technologies for rendering colored images.

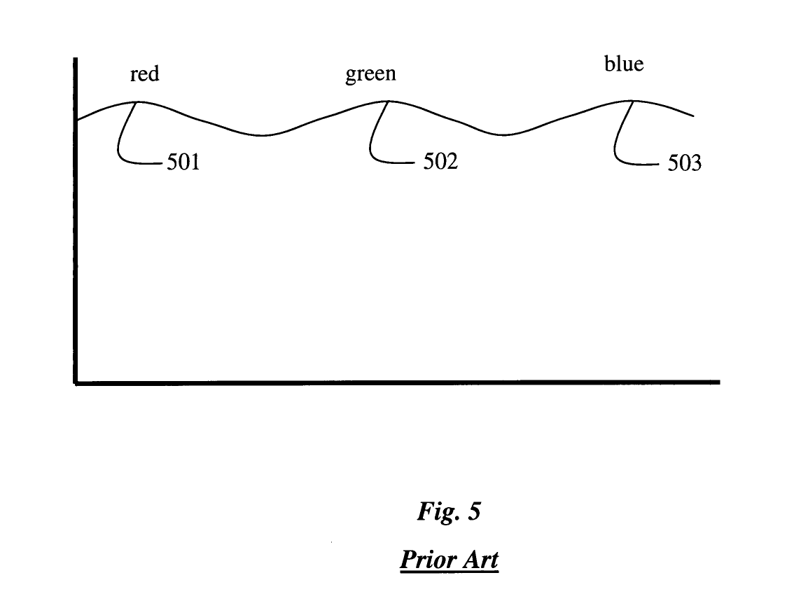

FIG. 5 shows the intensity of light from a typical prior art projector that is projecting a white image. The projector uses the fundamental RGB frequencies, as well as a broad range of surrounding frequencies. There are three peaks 501-503 corresponding to the three fundamental RGB colors used by the projector. Due to the properties of the human eye, the light in FIG. 5 appears as white light.

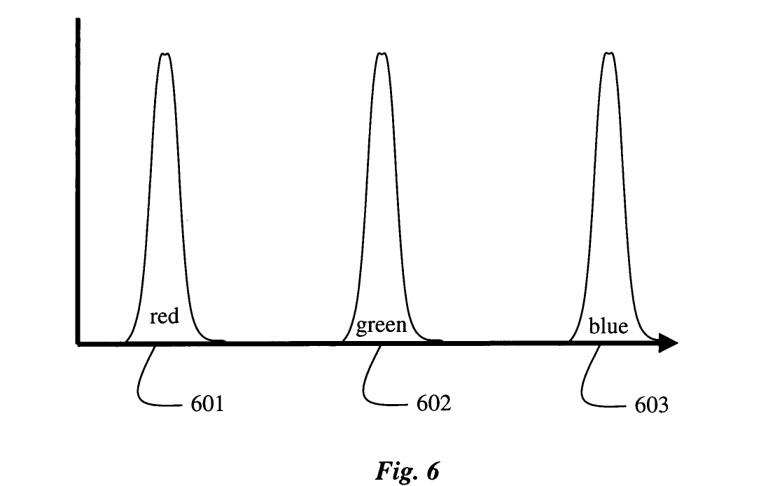

FIG. 6 shows the intensity of light from the narrow-band projector according to the invention that is projecting a white image. There are three narrow peaks 601-603 corresponding to the three fundamental RGB colors used by the projector. This light pattern also appears as white light.

It should be noted that a typical projector uses a broad range of light frequencies in order to make the most efficient use of the light source used by the projector. Projectors can use many different technologies to generate an image, such as transmission LCD panels, reflective liquid crystal on silicon elements, and multiple mirror devices, among others. However, the projectors primarily all use similar light sources, which are very bright bulbs, often high intensity direct discharge (HID) bulbs, producing wide-spectrum white light. This light is then broken up into red, green and blue light using wide-band filters so that as much as possible of the available light is used for the projection. This allows the image projected to be brighter for a given bulb wattage.

The filters in the projector according to the invention can be narrow-band filters producing narrow bands of red and green and blue light. However, this is an inefficient use of the HID bulb. Therefore, the preferred embodiment uses narrow-band light sources such as light emitting diodes (LEDs). LEDs can create very narrow bands of light very efficiently. By using a cluster of red, green, and blue LEDs as a light source, the narrow-band projector according to the invention efficiently generates white light.

When only ambient white light is reflected on the narrow-band screen according to the invention, only a small portion of the ambient light is reflected. The reflected light as about 10% or less of the incident ambient light. As a result, the screen appears black, even in a lighted room. This allows projected blacks to appear quite black, even in a lighted room.

When the narrow-band projector renders images on the narrow-band screen, almost all of the incident light is reflected. If the frequency bands in the narrow-band projector and a narrow-band screen are properly aligned, then the white reflected by the narrow-band screen is substantially as bright as an image projected by a conventional projector on a conventional screen. As a result, projected black is substantially darker than for conventional projectors and screens, while projected white is only marginally dimmer.

It should be noted that the narrow-band screen according to the invention can also be used with conventional projectors to enhance the appearance of projected images. It should also be noted that in order to achieve optimal performance, the narrow-band frequencies of the light emitted by the projector and the light reflected by the screen should match closely.

Even greater contrast can be achieved by using narrow-band room lights having colors that are not the same as the narrow bands reflected by the projection screen. In this case, the ambient light in the room will not be reflected by the narrow band screen, even when the intensity level of the light in the room is high.

It is to be understood that various other adaptations and modifications may be made within the spirit and scope of the invention. Therefore, it is the object of the appended claims to cover all such variations and modifications as come within the true spirit and scope of the invention.

1. A high contrast front projection system, comprising:
a reflective screen configured to reflect light in a plurality of narrow-band frequencies; and
a projector configured to emit light substantially in the plurality of narrow-band frequencies.

2. The system of claim 1, in which the plurality of narrow-band frequencies are centered on red, green, and blue colors.

3. The system of claim 1, in which the reflective screen reflects about 90% of light at the plurality of narrow-band frequencies, and less than 10% of light at other frequencies.

4. The system of claim 1, in which the reflective screen is coated with reflectors reflecting light at the plurality of narrow-band frequencies.

5. The system of claim 1, in which the reflective screen is coated with a filter absorbing light at frequencies other the plurality of narrow-band frequencies.

6. The system of claim 1, in which the projector uses transmission LCD panels.

7. The system of claim 1, in which the projector uses silicon elements.

8. The system of claim 1, in which the projector uses multiple mirror devices.

9. The system of claim 1, in which the projector uses light emitting diodes tuned to the plurality of narrow-band frequencies.

10. The system of claim 1, in which the projector emits light having wide-band frequencies.

11. The system of claim 5, in which the filters are interference filters.

12. The system of claim 11, in which the interference filters are constructed as a color hologram.

13. The system of claim 1, further comprising:
ambient light sources configured to emit light at frequencies other than the plurality of narrow-band frequencies.

14. A method for projecting high contrast images, comprising:
projecting images with a projector using narrow-band frequencies; and
reflecting the images on a screen configured to reflect light in the plurality of narrow-band frequencies.
